(19) United States
(12) Patent Application Publication
(10) Pub. No.: US 2006/0148301 A1
(43) Pub. Date: Jul. 6, 2006

(54) Connector

(76) Inventor: Tae-sang Kim, Suwon-si (KR)

Correspondence Address: STANZIONE & KIM, LLP, 919 18TH STREET, N.W., SUITE 440, WASHINGTON, DC, 20006, US

(21) Appl. No.: 11/283,890

(22) Filed: Nov. 22, 2005

(30) Foreign Application Priority Data
Dec. 30, 2004 (KR) 2004-116832

(51) Int. Cl. H01R 13/627

(52) U.S. Cl. 439/354

(57) ABSTRACT

A connector electrically coupled with a plug, includes a housing into which the plug is inserted, the housing having a plurality of contact pins and a locker connected with the housing, to be elastically coupled with one side of the plug when the plug is inserted into the housing so as to prevent the plug from being accidentally disconnected.

### CROSS-REFERENCE TO RELATED APPLICATIONS

This application claims the benefit under 35 U.S.C. § 119 from Korean Patent Application No. 2004-116832, filed on Dec. 30, 2004, in the Korean Intellectual Property Office, the disclosure of which is incorporated herein by reference in its entirety.

### BACKGROUND OF THE INVENTION

1. Field of the Invention

The present general inventive concept relates to a connector, and more particularly, to a connector having an improved coupling structure to be coupled to a plug.

2. Description of the Related Art

In the age of information-oriented society, demands for telephone communication network and local area network (LAN) have steadily increased. In addition, various communication methods having composite functions, such as Internet phones, have been developed.

The telephone communication network is mainly used in analog communication and therefore limited to communications with a facsimile or a personal computer, etc. The LAN is connectable to a router or a network server, and therefore the LAN can be connected to a digital communication network distributor such as a hub. The telephone communication network and the LAN are mainly connected via a standard phone four-wire connector RJ11, a standard phone eight-wire connector RJ45, and a combined connector of RJ11 and RJ45.

In a conventional connector illustrated in FIG. 1, a plug 1 is inserted into a connector 3, thereby allowing a support part 2 formed on the plug 1 to be elastically coupled with a hooking part 4 formed on the connector 3. When the plug 1 is inserted towards the connector 3, an elastic force of the support part 2 enables the support part 2 and the hooking part 4 to be locked in positions that prevent separation of the plug 1 and the connector 3.

However, because of a structural property connecting the connector 3 and the plug 1, it has been relatively inconvenient when the connector 3 is disconnected from the plug 1. It is possible that at least one of the plug 1 and the connector 3 is damaged due to environmental conditions or handling.

Particularly, since the connector 3 has an integral structure, even a minor damage makes it necessary to replace the connector 3 with a new one although only a part thereof (e.g. the hooking part 4) has been damaged.

### SUMMARY OF THE INVENTION

The present general inventive concept provides a connector capable of being easily coupled with a plug, firmly maintaining the coupling with the plug, and having a detachable coupling part that can be easily replaced if damaged.

Additional aspects of the present general inventive concept will be set forth in part in the description which follows and, in part, will be obvious from the description, or may be learned by practice of the general inventive concept.

The foregoing and/or other aspects of the present general inventive concept may be achieved by providing a connector electrically coupled with a plug, the connector comprising a housing into which the plug is inserted, the housing having a plurality of contact pins, and a locker connected with the housing and elastically coupled with one side of the plug when the plug is inserted into the housing so as to prevent the plug from being accidentally disconnected.

The locker may comprise a coupling part to be coupled with the housing, and a hooking part extended from the coupling part to elastically support the plug.

The coupling part may be detachably coupled to the housing.

At least one coupling projection may be formed on the housing, and at least one corresponding coupling hole may be formed on the coupling part to be coupled with the at least one coupling projection.

The foregoing and/or other aspects of the present general inventive concept may also be achieved by providing a connector having a plurality of electric connections to be connected with corresponding electric contacts of a plug, the connector comprising a connector body to surround the plurality of electric connections such that to allow the plug be inserted in the connector, and a safekeeping mechanism detachably mounted on the connector body to elastically deform when the plug is inserted in the connector and to prevent the plug from accidentally slip out of the connector.

The foregoing and/or other aspects of the present general inventive concept may also be achieved by providing a connector comprising a housing having a contact pin disposed inside the housing, an opening formed on the housing to allow an external device to be disposed inside the housing to access the contact pin, and a locker detachably attached to a portion of the housing to be coupled to the to the external device.

### BRIEF DESCRIPTION OF THE DRAWINGS

These and other aspects and advantages of the present general inventive concept will become apparent and more readily appreciated from the following description of the embodiments, taken in conjunction with the accompany drawings of which:

FIG. 1 is a perspective view illustrating a structure of a conventional connector and a plug;

FIG. 2 is a perspective view illustrating a structure of a connector and a plug according to the present general inventive concept;

FIG. 3 is a perspective view illustrating a coupled structure of the plug and the connector of FIG. 2; and

FIGS. 4A and 4B illustrate a coupling operation of connecting the connector with the plug of FIG. 2.

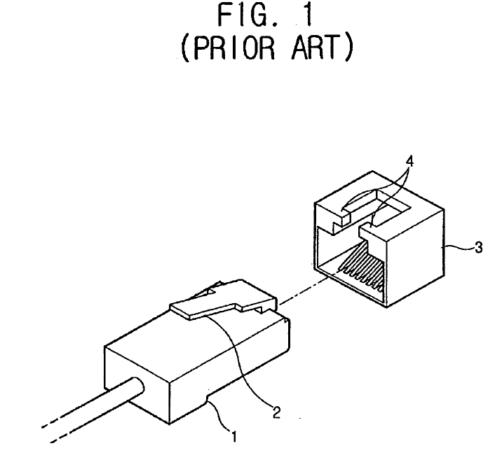

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

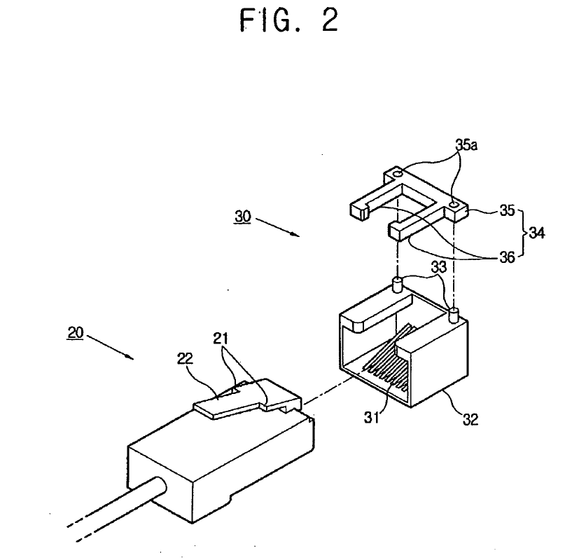

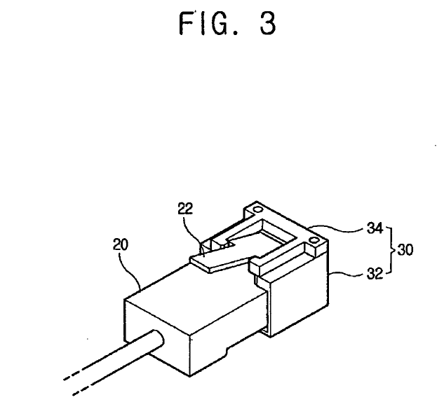

As illustrated in FIGS. 2 and 3, a connector 30 according to an embodiment of the present general inventive concept comprises a housing 32 formed with a plurality of contact pins 31, and a locker 34 installed on and connected to the housing 32. On a plug 20 electrically connected to the connector 30 is formed a support part 22 formed with an engagement projection 21.

The housing 32 may be made of plastic. The contact pins 31 within the housing 32 are electrically connected to a pin connecting part (not shown) formed on the plug 20 when the plug 20 is inserted into the connector 30.

A top of the housing 32 has a partial opening through which the support part 22 of the plug 20 may be inserted in an insertion direction.

The locker 34 includes a coupling part 35 that can be coupled with the top of the housing 32, and a hooking part 36 extended from the coupling part 35 toward the plug 20 in a direction opposite to the insertion direction. The hooking part 36 may be elastically deformed when the plug 20 is inserted into the connector 30.

The coupling part 35 is detachably coupled to the housing 32. At least one coupling projection 33 may be formed on the housing 32 and at least one coupling hole 35a corresponding to the at least one coupling projection 33 may be formed on the coupling part 34. FIGS. 2, 3, 4A and 4B illustrate embodiments having two coupling projections 33 and two coupling holes 35. Accordingly, when the locker 34 is damaged, there is no need to replace the whole connector 30 and replacing the locker 34 alone is sufficient. That is, a user does not need to replace the housing 32.

The coupling projections 33 of the housing 32 may be forced to be inserted into the corresponding coupling holes 35a of the coupling part 35. A coupling method and structure to connect the locker 34 with the housing 32 may be embodied in alternative according to several methods publicly known other than the method described above. The present general inventive concept is not limited to the present embodiment of the coupling method.

The hooking part 36 may include a pair of extensions, which may elastically react according to a connection operation or a disconnection operation of the plug 20. That is, the hooking part 36 may be connected to or disconnected from the engagement projection 21 formed on the support part 22 of the plug 20. The shape and structure of the hooking part 36 may be embodied variously.

The locker 34 is elastically coupled with one side of the plug 20 when the plug 20 is inserted into the housing 32. A structure of the locker 34 may be changed variously within the limitation that the structure of the locker 34 should prevent an uncontrolled disconnection of the plug 20. The locker 34 may be made of plastic which has a persistence and corrosion resistance and can supply a predetermined tension force to the hooking part 36. The locker 34 can be made of different and various materials that have similar properties to plastic.

In the present general inventive concept, the plug 20 may have a variety of publicly known shapes as long as the shapes include parts for corresponding coupling with the locker 34.

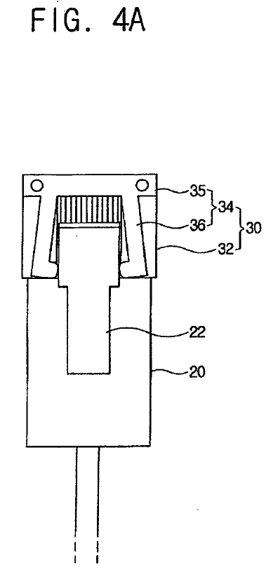

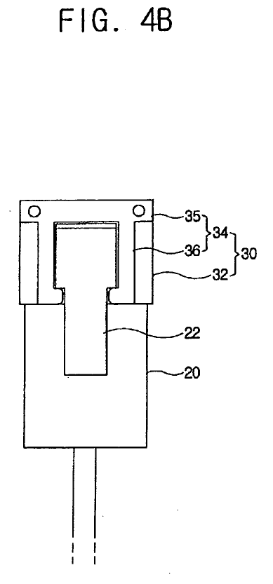

FIGS. 4A and 4B illustrate a coupling operation of connecting the connector 30 with the plug 20 of FIG. 2.

Referring to FIGS. 2, 4A and 4B, the plug 20 is inserted into the housing 32 of the connector 30, and the pair of extensions of the hooking part 36 extended from the coupling part 35 of the locker 34 are in contact with the support part 22 formed on the plug 20 as illustrated in FIG. 4A, whereby the extensions of the hooking part 36 are pushed away in lateral directions increasing a distance in-between to allow the support part 22 to advance towards the coupling part 35. Because of the elastic deformation of the extensions of the hooking part 36 as shown in FIG. 4A, a tension force is exerted on sides of the supporting part 22 of the plug 20.

When the plug 20 is completely inserted into the housing 32 of the connector 30, the pair of extensions of the hooking part 36 extended from the coupling part 35 of the locker 34 are restored to their original state as illustrated in FIG. 4B. The distance between the pair of extensions of the hooking part 36 becomes smaller as ends of the pair of extensions of the hooking part 36 reach a narrower part of the support part 22, thereby firmly supporting the support part 22 of the plug 20. As illustrated in FIG. 4B, when the plug 20 is inserted in the connector 30, the extensions of the hooking part 36 fit in corresponding ones of the narrower parts of the support part 22 to prevent an accidental separation of the plug 20 and the connector 30.

As described above, the present general inventive concept may serve to facilitate coupling of the connector with the plug and firmly maintaining the coupling state by changing the structure of the connector.

In addition, the present general inventive concept prevents damage occurring when the connector is coupled with the plug.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A connector electrically coupled with a plug, comprising:
a housing having a plurality of contact pins and to receive a plug inserted therein; and
a locker connectable with the housing, to be elastically coupled with one side of the plug when the plug is inserted into the housing so as to prevent the plug from being accidentally disconnected.

2. The connector according to claim 1, wherein the locker comprises:
a coupling part to be coupled with the housing; and
a hooking part extended from the coupling part to elastically support the plug.

3. The connector according to claim 2, wherein the coupling part is detachably coupled to the housing.

4. The connector according to claim 3, wherein:
the housing comprises at least one coupling projection; and
the coupling part comprises at least one corresponding coupling hole to be coupled with the at least one coupling projection.

5. A connector having a plurality of electric connections to be connected with corresponding electric contacts of a plug, the connector comprising:
a housing to accommodate the plurality of electric connections and an opening through which the plug is inserted into the housing; and
a locker detachably mounted on the connector body to elastically deform when the plug is inserted in the connector and to prevent the plug from accidentally detach from the connector.

6. The connector according to claim 5 wherein if the locker is damaged, the locker is replaced without replacing the housing.

7. The connector according to claim 5, wherein the locker comprises:
a coupling part to detachably connect the locker to the connector; and
a hooking part to elastically deform when the plug is inserted in the connector and to prevent the plug from accidentally slip out of the connector.

8. The connector according to claim 7, wherein the coupling part comprises:
one or more mounting holes to forcefully have inserted corresponding one or more coupling projections formed on the housing.

9. The connector according to claim 7, wherein the coupling part comprises:
one or more mounting coupling projections to be forcefully inserted into corresponding one or more holes formed on the housing.

10. The connector according to claim 7 wherein the hooking part comprises:
at least one pair of hooking extensions extending in a direction opposite to a direction of inserting the plug in the connector, to elastically deform increasing a distance in-between when a first part of the plug passes therethrough and to lock around a second part of the inserted plug, wherein the second part of the plug is narrower than the first part of the plug.

11. A connector, comprising:
a housing having a contact pin disposed inside the housing, an opening formed on the housing to allow an external device to be disposed inside the housing to access the contact pin; and
a locker detachably attached to a portion of the housing to be coupled to the to the external device.

12. The connector according to claim 11, wherein the locker comprises:
a coupling part detachably attached to the portion of the housing; and
a hooking part extended from the coupling part to be coupled to the external device.

13. The connector according to claim 12, wherein the hooking part is disposed along a direction having an angle with an insertion direction in which the external device is inserted into the housing.

14. The connector according to claim 13, wherein the hooking part comprises:
first and second ends disposed in the direction;
first and second coupling holes formed on the first and second ends; and
first and second coupling projections formed on the housing to be coupled to the locker through the first and second coupling holes, respectively.

15. The connector according to claim 13, wherein the hooking part comprises:
distal ends disposed along the direction to be coupled to the housing.

16. The connector according to claim 11, wherein the locker comprises:
a hooking part extended along the opening.

17. The connector according to claim 11, wherein the locker comprises:
extensions to be coupled to the external device, and the extensions move in a first direction and a second direction with respect to the housing.

18. The connector according to claim 17, wherein the housing receives the external device through the opening in an insertion direction, and the first and second directions are different from the insertion direction.

19. The connector according to claim 11, wherein the locker is deformed when the housing receives the external device, and the housing is not deformed when receiving the external device.

20. The connector according to claim 11, wherein the locker is not disposed within the housing.

21. The connector according to claim 11, wherein the portion of the housing is disposed outside the opening.

22. The connector according to claim 11, wherein the housing comprises:
an external surface and the locker is formed on the external surface of the housing.

23. The connector according to claim 11, wherein the portion of the housing is not disposed on a surface defining the opening.
